(19) United States
(12) Patent Application Publication
(10) Pub. No.: US 2009/0019823 A1
(43) Pub. Date: Jan. 22, 2009

(54) Auxiliary Power Unit Exhaust Filter

(76) Inventors: William Michael Juliar, Coon Rapids, MN (US); Gary Dale Reeves, Lakeville, MN (US); David Thomas Escher, Brooklyn Park, MN (US); John Wiese, Lakeville, MN (US)

Correspondence Address: MERCHANT & GOULD PC, P.O. BOX 2903, MINNEAPOLIS, MN, 55402-0903, US

(21) Appl. No.: 12/142,944

(22) Filed: Jun. 20, 2008

Related U.S. Application Data
(60) Provisional application No. 60/936,574, filed on Jun. 20, 2007.

(51) Int. Cl. B01D 53/92

(52) U.S. Cl. 55/472; 55/498; 55/502; 55/484

(57) ABSTRACT

The present disclosure relates to an exhaust filter including an inner cylindrical pleated filter media and an outer cylindrical pleated filter media positioned outside the inner cylindrical pleated filter media. The inner and outer cylindrical pleated filter media are separated by an annular gap. The inner cylindrical pleated filter media has a shorter length than the outer cylindrical pleated filter media. The exhaust filter also include a first end cover in which first ends of the inner and outer cylindrical pleated filter media are secured, a second end cover in which a second end of the outer cylindrical pleated filter media is secured, and an interior end cap in which a second end of the inner cylindrical pleated filter media is secured. The exhaust filter further includes an inlet stub secured to the second end cover. The exhaust filter can be mounted in an outer housing having a compression gasket sealing arrangement for providing a seal about the inlet stub of the exhaust filter.

### CROSS-REFERENCE TO RELATED APPLICATION

This application claims the benefit of U.S. Provisional Patent Application Ser. No. 60/936,574 filed Jun. 20, 2007, which application is hereby incorporated by reference in its entirety.

### TECHNICAL FIELD

The present invention relates generally to air filters. More particularly, the present invention relates to air filters for use in exhaust systems.

### BACKGROUND

Engine exhaust filters can have a variety of constructions. One type of exhaust filter includes a cellular ceramic core defining a honeycomb of channels having plugged ends. Filters having this construction are disclosed in U.S. Pat. Nos. 4,276,071 and 4,851,015. Other exhaust filters include a filter media defined by a plug of wire mesh. Filters having this construction are disclosed in U.S. Pat. Nos. 3,499,269 and 4,902,487.

Filters are also often used to filter the intake air drawn into an engine. U.S. Pat. Nos. 3,078,650 and 5,547,480 disclose air filters of the type used with the intake systems of engines. These filters include cylindrical pleated filter elements mounted within housings. The filter elements define hollow interiors, and the air being filtered travels radially through the pleated filter elements. While suitable for engine intake applications, these types of filters are not typically adapted for the high temperature environment created by engine exhaust.

Pleated cylindrical filters have also been used to filter diesel engine exhaust. For example, U.S. Publication No. 2005/0126138 discloses a pleated filter adapted for use in high temperature exhaust (e.g., in temperatures greater than 300 degrees Fahrenheit).

Engine emission regulations have become increasingly stringent and more widely applicable. For example, recent regulations implemented by the California Air Resources Board have required auxiliary power units provided on 2007 or newer trucks to comply with the level 3 emissions standard. The level 3 emissions standard requires an 85 percent reduction in particulate material as compared to baseline emissions generated by the source of exhaust emissions. What are needed are alternative filtration systems for use in applications such as treating diesel exhaust generated by auxiliary power units and other applications.

### SUMMARY

One aspect of the present disclosure relates to an air filter having a design suitable for the air filter to be used in a relatively high temperature environment such as an engine exhaust system. In one embodiment, the air filter includes inner and outer cylindrical, pleated filter elements.

Another aspect of the present disclosure relates to a sealing configuration provided between an outer housing and an inlet stub of a filter element.

Examples of a variety of aspects in addition to those described above are set forth in the description that follows. It is to be understood that both the foregoing general description and the following detailed description are exemplary and explanatory and are not restrictive of the broad inventive aspects which provide a basis for the examples disclosed herein.

### BRIEF DESCRIPTION OF THE DRAWINGS

FIG. 1 schematically shows an example system in which filters in accordance with the principles of the present disclosure may be utilized;

FIG. 2 is a perspective view showing a first end of an exhaust filter having features that are examples of inventive aspects in accordance with the principles of the present disclosure;

FIG. 3 is a perspective view of a second end of the exhaust filter of FIG. 2;

FIG. 4 is an end view of the first end of the exhaust filter of FIG. 2;

FIG. 5 is an end view of the second end of the exhaust filter of FIG. 3;

FIG. 6 is a cross-sectional view taken along section line 6-6 of FIG. 5;

FIG. 7 is an end view of an interior end cap used at a first end of an inner cylindrical pleated filter media of the exhaust filter of FIGS. 2-6;

FIG. 8 is a cross-sectional view taken along section line 8-8 of FIG. 7;

FIG. 9 is an end view of a first end cover of the exhaust filter of FIGS. 2-6;

FIG. 10 is a cross-sectional view taken along section line 10-10 of FIG. 9;

FIG. 11 is an end view of a second end cover of the exhaust filter of FIGS. 2-6;

FIG. 12 is a cross-sectional view taken along section line 12-12 of FIG. 11;

FIG. 13 is a side view of an outer cylindrical pleated filter media of exhaust filter of FIGS. 2-6;

FIG. 14 is an end view of the outer cylindrical pleated media of FIG. 13;

FIG. 15 is a side view of an inner cylindrical pleated filter media of the exhaust filter of FIGS. 2-6;

FIG. 16 is an end view of the inner cylindrical pleated filter media of FIG. 15;

FIG. 17 is an end view of an inner cylindrical liner that fits within the interior of the inner cylindrical pleated filter media of FIGS. 15 and 16;

FIG. 18 is an end view of the inner liner of FIG. 17;

FIG. 19 is a side view of an outer liner that fits around the exterior of the outer cylindrical pleated filter media of FIGS. 13 and 14;

FIG. 20 is an end view of the outer liner of FIG. 19;

FIG. 21 is a side view of a cylindrical inlet stub that is secured to a central region of the first end cover of FIGS. 9 and 10;

FIG. 22 is an end view of the inlet stub of FIG. 21;

FIG. 23 is a cross-sectional view taken though a section of pleated filter media; and

FIG. 24 is a cross-sectional view taken along section line 24-24 of FIG. 25, the view shows the exhaust filter of FIGS. 2-6 assembled within an outer housing having features that are examples of aspects in accordance with the principles of the present disclosure;

FIG. 24A is an enlarged view of a portion of FIG. 24;

FIG. 24B is an enlarged view of another portion of FIG. 24;

FIG. 25 is a left end view of the assembly of FIG. 24;

FIG. 26 is a right end view of the assembly of FIG. 24;

FIG. 27 is an end view of a core support that stabilizes the exhaust filter of FIGS. 2-6 within the outer housing of FIGS. 24-26;

FIG. 28 is a cross-sectional view taken along section line 28-28 of FIG. 29, the view shows the exhaust filter of FIGS. 2-6 assembled within another outer housing having features that are examples of aspects in accordance with the principles of the present disclosure;

FIG. 29 is a left end view of the assembly of FIG. 28;

FIG. 30 is a right end view of the assembly of FIG. 28;

FIG. 31 is an end view of a core support that stabilizes the exhaust filter of FIGS. 2-6 within the outer housing of FIGS. 28-30; and

FIG. 32 shows the outer housing of FIG. 24 modified to include an additional gasket compression flange.

### DETAILED DESCRIPTION

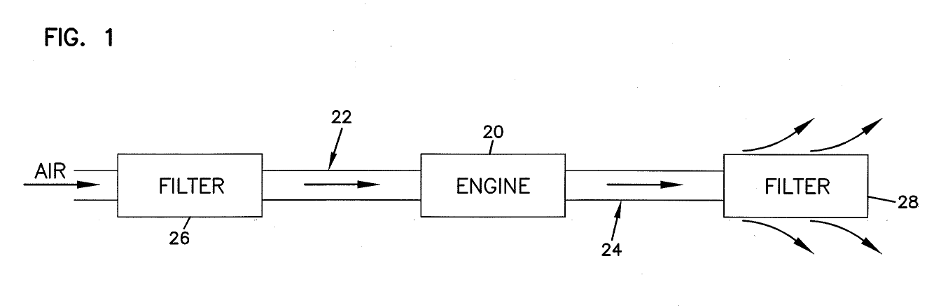

FIG. 1 schematically illustrates an engine 20 having an intake system 22 and an exhaust system 24. An air filter 26 can be provided as part of the intake system 22 to remove particles from the air drawn into the engine 20. An exhaust filter 28 in accordance with the principles of the present disclosure can be provided at the exhaust system 24 for removing volatile particulates as well as non-volatile particulates such as carbon-based particulates (e.g., soot) from the exhaust stream. In certain embodiments, the engine 20 can be a diesel engine such as the type used in an auxiliary power unit of an over-the-road truck. Auxiliary power units are used to provide electricity, heating, cooling, and other cab functions when the truck is not being driven. A typical auxiliary power unit includes a diesel engine having a power rating of 12 horsepower or less. Such engines typically generate an exhaust stream having a temperature in the range of 200-500 degrees Fahrenheit with occasional relatively short temperature excursions that may reach or exceed 600 degrees Fahrenheit. It will be appreciated that filters in accordance with the principles of the present disclosure can also be used for applications other than the treatment of auxiliary power unit exhaust.

A. Example Exhaust Filter Assembly

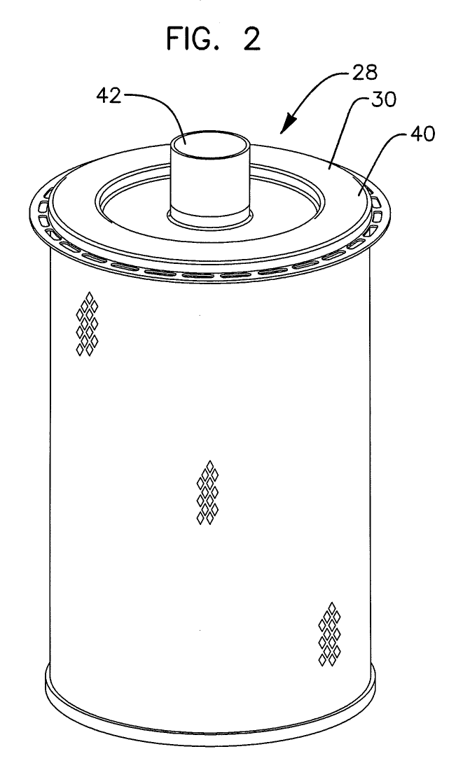

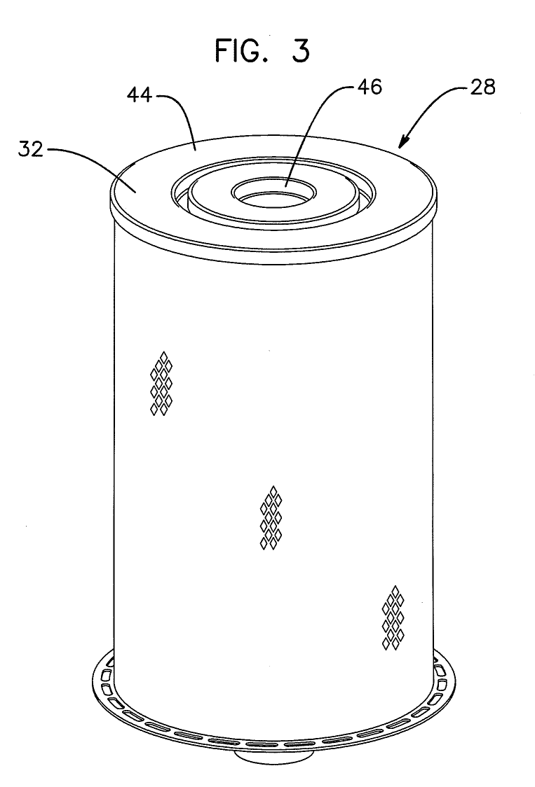

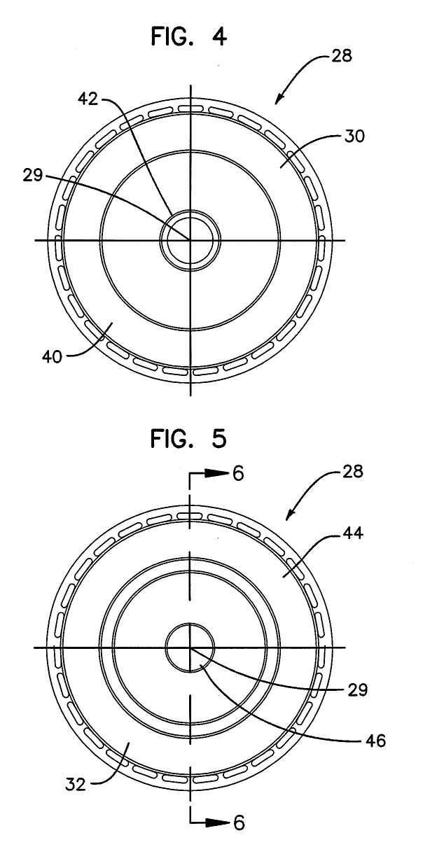

FIGS. 2-6 illustrate an exhaust filter 28 having features that are examples of inventive aspects in accordance with the principles of the present disclosure. The exhaust filter 28 includes a central axis 29 that extends from a first end 30 to a second end 32 of the exhaust filter 28. The exhaust filter 28 also includes concentrically aligned inner and outer cylindrical pleated filter media 34, 36 that are centered about the central axis 29. An annular gap 38 is positioned between the inner cylindrical pleated filter media 34 and the outer cylindrical pleated filter media 36. The first end 30 of the exhaust filter 28 is enclosed by a first end cover 40 and the second end 32 of the exhaust filter 28 is enclosed by a second end cover 44. An inlet stub 42 extends through the center of the first end cover 40 and the second end cover 44 defines a central outlet opening 46. The exhaust filter 28 further includes an interior end cap 48 mounted at a first end 34, of the inner cylindrical pleated filter media 34, a cylindrical outer shell 50 (i.e., an outer liner) that mounts at the outer diameter of the outer cylindrical pleated filter media 36 and a cylindrical inner liner 52 (i.e., an inner shell) that mounts at the inner diameter of the inner cylindrical pleated filter media 34.

In general use of the exhaust filter 28, an exhaust stream is directed into the exhaust filter 28 through the inlet stub 42. Upon entering the exhaust filter 28, the exhaust stream flows into the annular gap 38. From the annular gap 38, some of the exhaust stream flows radially outwardly through the outer cylindrical pleated filter media 36 as indicated by arrows 54. The remainder of the exhaust stream flows radially inwardly from the annular gap 38 through the inner cylindrical pleated filter media 34 as indicated by arrows 56. The exhaust that passes through the inner cylindrical pleated filter media 34 enters a central passage 55 of the inner cylindrical pleated filter media 34 and exits the exhaust filter 28 through the central outlet opening 46. Based on the above description, the outer side of the inner cylindrical pleated filter media 34 is dirty while the inner side of the inner cylindrical pleated filter media 34 is clean. In contrast, the inner side of the outer cylindrical pleated filter media 36 is dirty while the outer side of the outer cylindrical pleated filter media 36 is clean. As will be described later in the specification, the exhaust filter 28 can be housed within an enclosure/housing that directs the filtered exhaust that passes through the inner and outer cylindrical pleated filter media 34, 36 to a single outlet location.

B. Example Filter Media

The inner and outer filter media 34, 36 preferably each have a construction suitable for relatively high temperature applications such as for filtering exhaust generated by auxiliary power units. Further details regarding media suitable for high temperature applications are disclosed at U.S. Publication No. 2005/0126138, which is hereby incorporated by reference in its entirety.

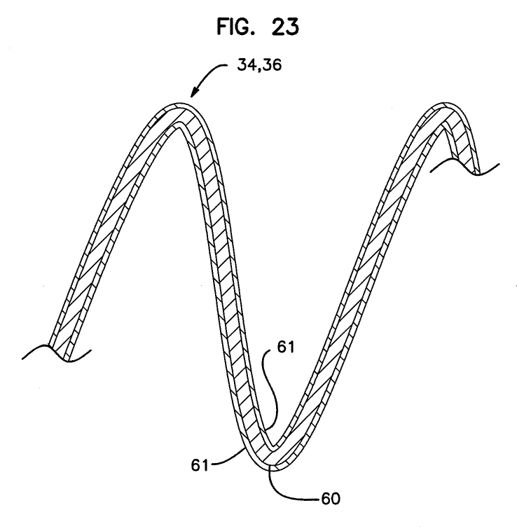

In one embodiment, the filter media 34, 36 are folded into a pleated configuration, and rolled into a cylinder. As shown at FIG. 23, the filter media 34, 36 have a laminated construction with a layer of filter material 60 secured between two layers of reinforcing material or scrim such as mesh screen 61 or expanded metal. In certain embodiments, the filter media each include a layer of fibers (e.g., glass or ceramic fibers). The layer can include woven or non-woven (e.g., matted) fibers. An example material includes a fiberglass filter material is sold by Filtration Specialties Inc. under the name Dynaglas® 2201. Other materials capable of withstanding relatively high temperatures, whether fibrous or non-fibrous, can also be used. In other embodiments, the media can be supported by a single reinforcing layer rather than being sandwiched between two reinforcing layers. Certain other embodiments may not include any reinforcing layers.

In certain embodiments, the screen 61 can include a mesh coated with a protective layer. The mesh can be manufactured of a metal material such as metal wire. In one embodiment, the metal material can include steel with a residual outer layer of copper. The protective layer provides a number of functions. First, the layer is preferably capable of withstanding temperatures comparable to those specified with respect to the filter media. The protective layer resists corrosion of the screen 61. In embodiments where the material of the screen includes copper, the protective layer isolates the copper from the exhaust stream to prevent the copper from reacting with sulfur in the exhaust stream and generating copper sulfate. An example protective layer includes an aluminum paint material or an epoxy coating.

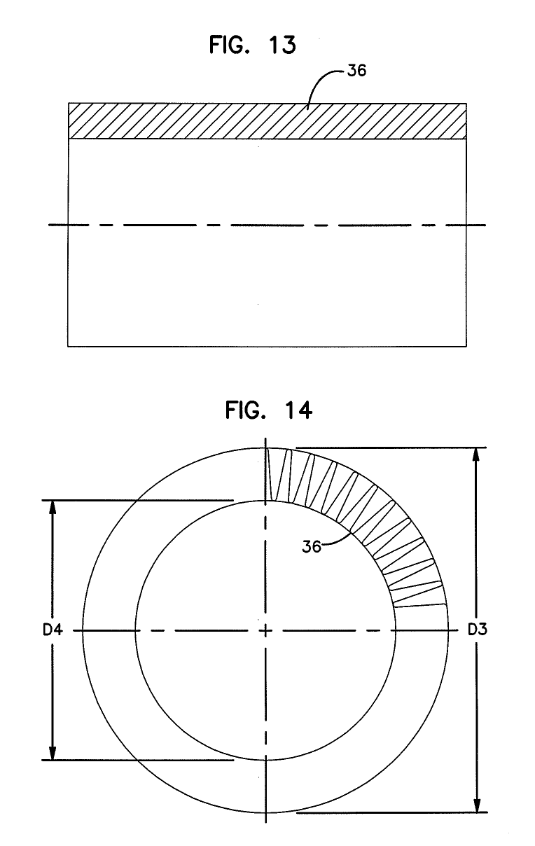

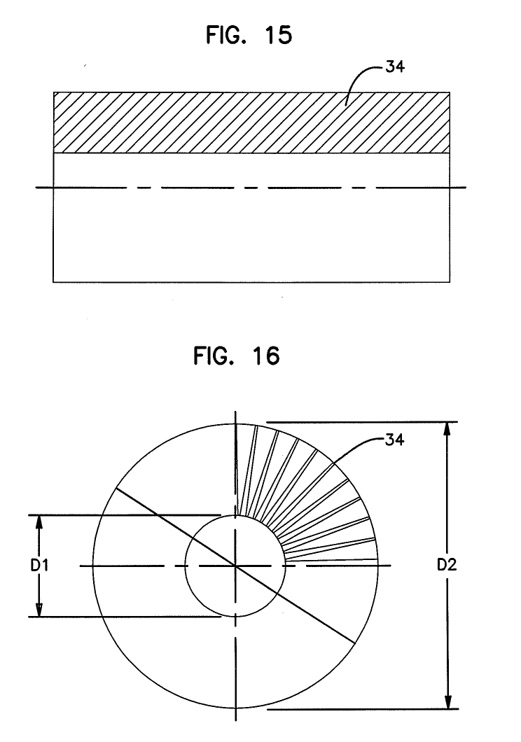

The inner cylindrical pleated filter media 34 has a smaller diameter than the outer cylindrical pleated filter media 36. For example, in one embodiment, the inner cylindrical pleated filter media 34 has an inner diameter D1 (see FIGS. 15 and 16) of about 2.22 inches and an outer diameter D2 (see FIGS. 15 and 16) of about 6.22 inches; and the outer cylindrical pleated filter media 36 has an outer diameter D3 (see FIGS. 13 and 14) of about 10.32 inches and an inner diameter D4 (see FIGS. 13 and 14) of about 7.32 inches. Additionally, the inner cylindrical pleated filter media 34 is shown having a pleat depth that is greater than the pleat depth of the outer cylindrical pleated filter media 36. In one embodiment, the pleat depth of the inner cylindrical pleated filter media 34 is at least 20 percent larger than the pleat depth of the outer cylindrical pleated filter media 36. To prevent soot from bridging the pleat tips, it is desirable for the cylindrical pleated filter media 34, 36 to have a pleat spacing of no more than 2 pleats per inch measured from pleat tip to pleat tip at the dirty sides of the media 34, 36. The selection of pleat depth, filter media diameter and filter media length can assist in optimizing the amount of filter media provided per volume to provide an effective and compact arrangement. It will be appreciated that the dimensions described above are merely examples of dimensions that can be used, and that filters having lengths, diameters and pleat depth different from those described above are within the scope of the present disclosure.

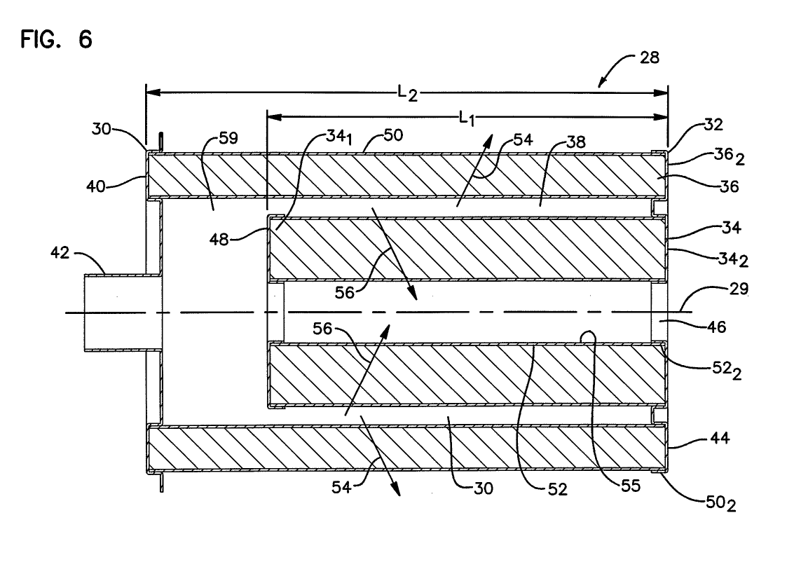

Referring to FIG. 6, the inner cylindrical pleated filter media 34 has a length L1 that is shorter than a corresponding length L2 of the outer cylindrical pleated filter media 36. In one embodiment, the length L1 is at least 10 percent shorter than the length L2. This variation in length provides an open region 59 within the exhaust filter 28 adjacent the inlet stub 42. The open region 59 assists in transitioning exhaust flow from the inlet stub 42 to the annular gap 38.

C. End Covers, End Caps, Inlets and Shells/Liners

Components such as end caps, covers, cores, inlet stubs, or shells used in filters in accordance with the present disclosure preferably have a construction adapted to resist degradation/deterioration when exposed to high temperatures such as those present in the exhaust stream of an engine. In a preferred embodiment, some or all of the components have an aluminized steel construction. Of course, other materials could be used as well.

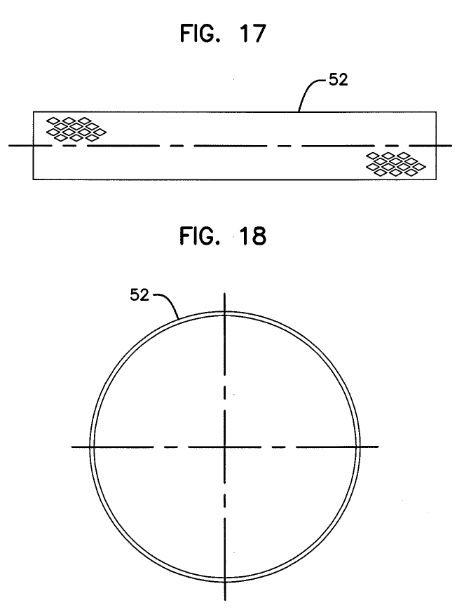

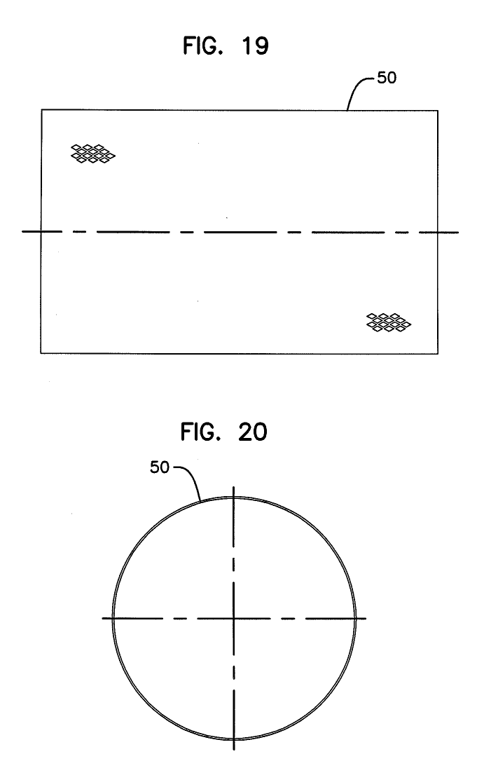

The inner liner 52 (see FIGS. 6, 17 and 18) of the exhaust filter 28 is configured to provide support or reinforcement to the inner diameter of the inner cylindrical pleated filter media 34 and forms a central hollow core of the exhaust filter 28. The inner liner assists in preventing the inner cylindrical pleated filter media 34 from collapsing and also assists in maintaining pleat spacing. The hollow interior of the inner liner 52 corresponds with the open central passage 55 and allows exhaust filtered by the inner cylindrical pleated filter element 34 to exit the exhaust filter 28 through the central outlet opening 46. The inner liner 52 preferably has an open mesh or screen-like configuration that allows exhaust gas to readily pass there through. For example, the inner liner 52 can have a perforated metal construction, an expanded metal construction, or other constructions.

The outer shell 50 (see FIGS. 6, 19 and 20) is configured to provide reinforcement or support about the outer diameter of the outer cylindrical pleated filter media 36. The outer shell 50 prevents billowing of the pleats and assists in maintaining pleat spacing. The outer shell 50 preferably has an open screen or mesh-like configuration that allows exhaust stream to pass readily there through. For example, the outer shell 50 can be manufactured of perforated metal, expanded metal, or other materials that allow exhaust to pass readily there through.

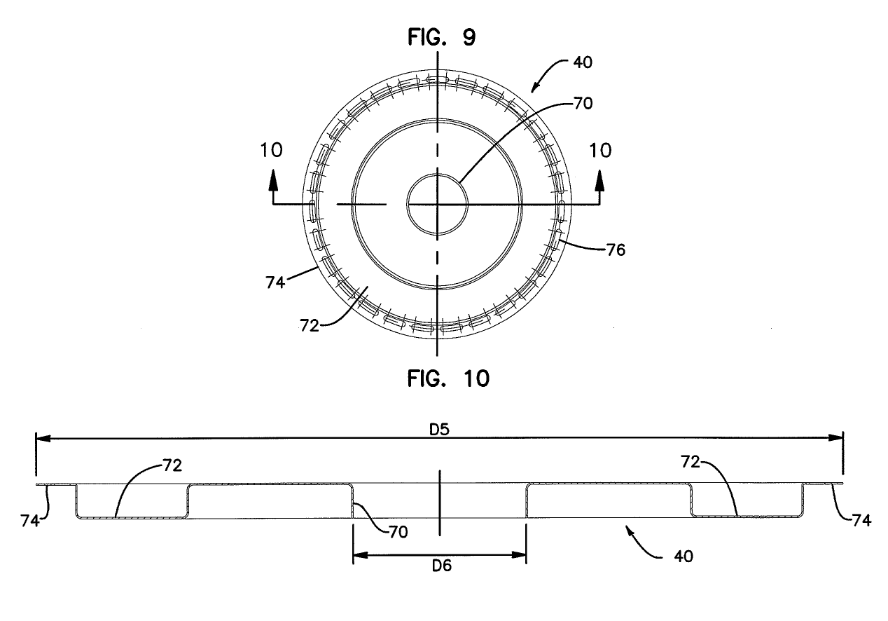

The first end cover 40 (see FIGS. 2, 4, 6, 9 and 10) of the exhaust filter 28 is configured to enclose the first end 30 of the exhaust filter 28. The first end cover 40 defines a central opening 70 in which the inlet stub 42 is secured (e.g., welded). The first end cover 40 also defines an annular channel 72 in which a first end 36, of the outer cylindrical pleated filter media 36 is sealed and secured (e.g., with a potting material). A first end 501 of the outer shell 50 fits inside the annular channel 72 and is secured to the first end cover 40. The first end cover 40 further includes an outer radial flange 74 that extends about the circumference of the first end cover 40. The outer radial flange 74 defines a plurality of openings 76.

The first end cover 40 is preferably configured to substantially enclose the first end 30 (i.e., the dirty end) of the exhaust filter 28 so that soot and other trapped material is enclosed within the exhaust filter 28. By enclosing the filtered material within the exhaust filter 28, handling of the exhaust filter 28 for replacement or possible cleaning is facilitated because the filtered material is trapped within the annular gap 38 and prevented from readily escaping or otherwise becoming displaced from the exhaust filter 28. In the depicted embodiment, the first end cover 40 has an outer diameter D5 that is generally equal to the outer diameter D3 of the outer cylindrical pleated filter media 36, and an inner diameter D6 that is generally equal to the outer diameter of the inlet stub 42. It is preferred for the outer diameter D5 to be substantially larger than the inner diameter of the inlet stub 42 so that a majority of the dirty side of the exhaust filter 28 is enclosed. In certain embodiments, the outer diameter D5 is at least three or four times larger than the inner diameter of the inlet stub 42.

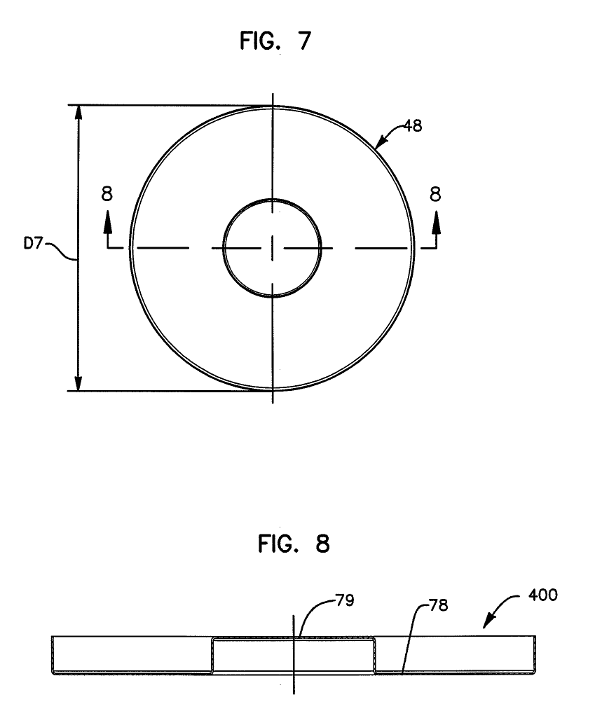

Referring to FIGS. 6, 7 and 8, the interior end cap 48 defines an outer diameter D7 that is generally equal to the outer diameter D2 of the inner cylindrical pleated filter media 34. The interior end cap 48 defines an annular channel 78 in which the first end 34, of the inner cylindrical pleated filter media 34 is sealed and secured (e.g., with a potting material). The interior end cap 48 also includes a central hub 79 that prevents dirty exhaust flow from entering the open central passage 55 defined within the inner liner 52. Additionally, a first end 52, of the inner liner 52 fits over and is secured to the central hub 79.

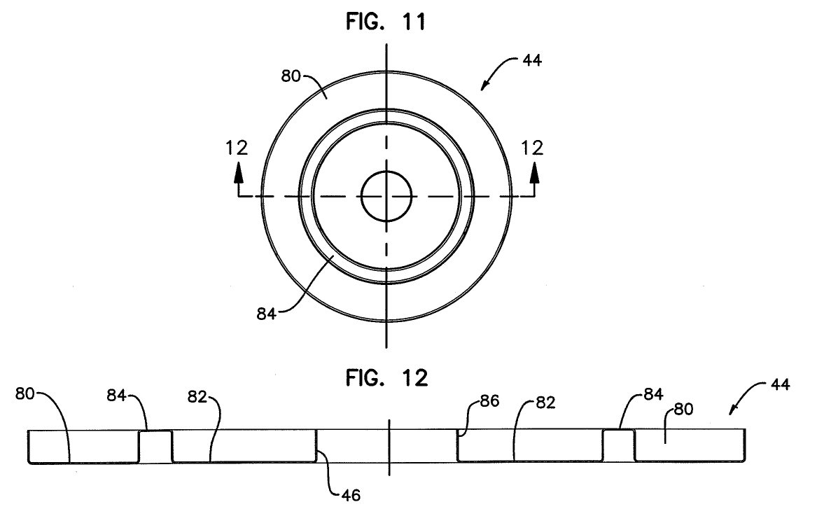

The second end cover 44 functions to enclose the second end 32 of the exhaust filter 28. As shown at FIGS. 11 and 12, the second end cover 44 defines an outer annular channel 80 in which a second end 362 of the outer cylindrical pleated filter media 36 is sealed and secured (e.g., with a potting material) and an inner channel 82 in which a second end 342 of the inner cylindrical pleated filter media 34 is sealed and secured (e.g., with a potting material). A second end 502 of the outer shell 50 is inserted into the outer annular channel 80 and is secured to the second end cover 44. The second end cover 44 defines an annular projection 84 located between the outer and inner annular channels 80, 82. As shown at FIG. 6, the annular projection 84 fits between the inner and outer cylindrical pleated filter medias 34, 36 adjacent the second end 32 of exhaust filter 28 to prevent dirty exhaust from bypassing the inner and outer cylindrical pleated filter media 34, 36 at the second end 32 of the exhaust filter 28. The second end cover 44 also includes an annular stem 86 that defines the central outlet opening 46. A second end 522 of the inner liner 52 is inserted over and secured to the annular stem 86 (see FIG. 6).

It will be appreciated that a variety of materials can be used as potting material at the interior end cap 48 and the end covers 40, 44 of the exhaust filter 28. In one embodiment, the potting material includes silicon.

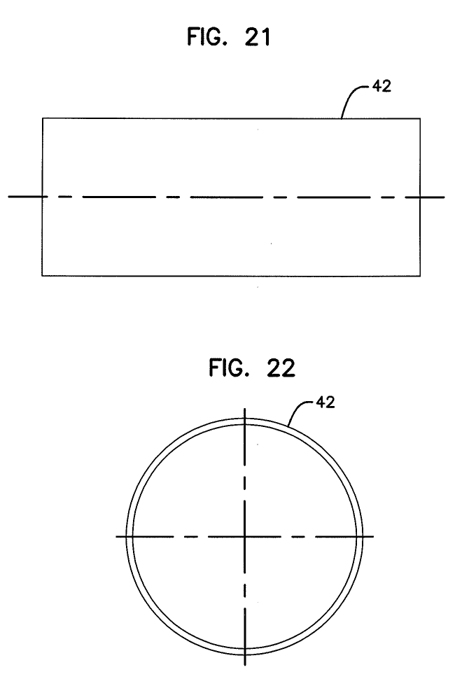

Referring to FIGS. 21 and 22, the inlet stub 42 has a solid tube construction. As shown at FIG. 6, the inlet stub 42 is secured (e.g., welded) within the central opening 70 of the first end cover 40.

D. Outer Housing

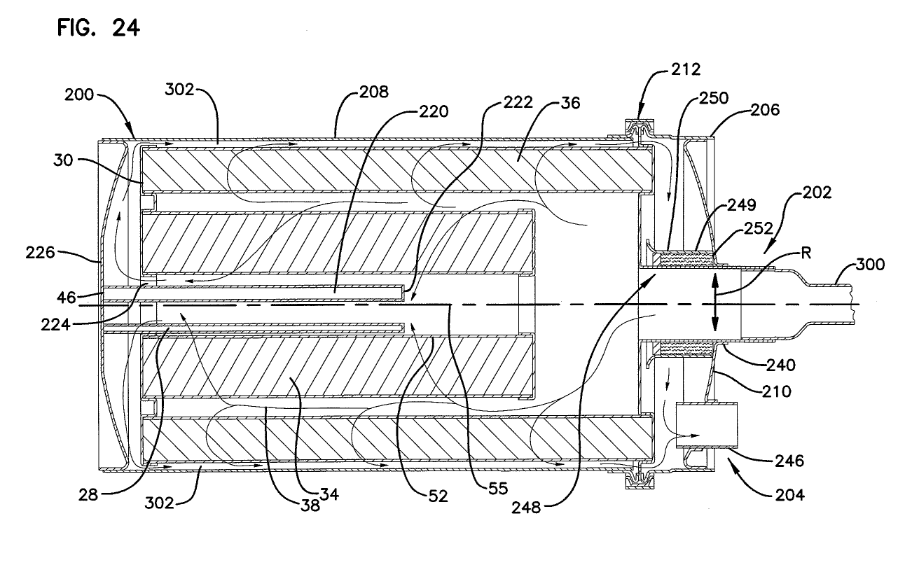

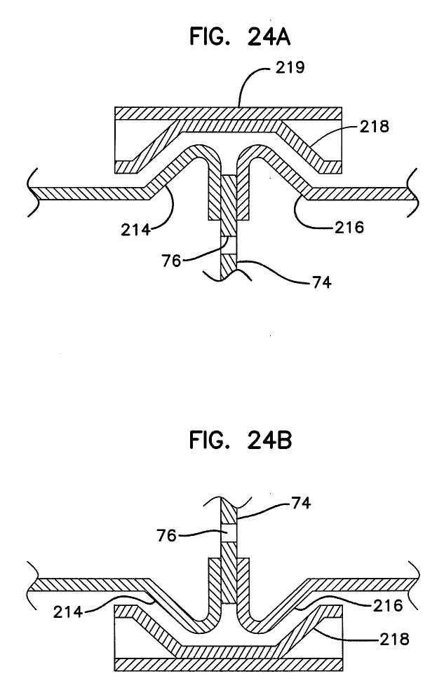

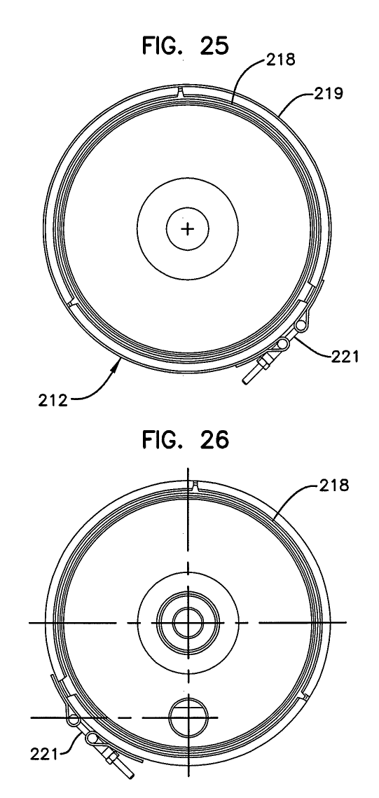

Referring to FIGS. 24-27, the exhaust filter 28 is shown mounted within an outer housing 200 (i.e., an outer enclosure) having features that are examples of inventive aspects in accordance with the principles of the present disclosure. The outer housing 200 is configured to reverse exhaust flow such that an inlet 202 and an outlet 204 of the outer housing 200 are located at one end 206 of the outer housing 200. Preferably, the outer housing 200 is configured to be readily disassembled to provide easy access to the exhaust filter 28. For example, the outer housing 200 can include a canister piece 208 and a cap piece 210 that are fastened together by a clamp such as a v-band clamp 212. The cap piece 210 forms the inlet/outlet end 206 of the outer housing 200 and functions to enclose/cover an open end 228 of the canister piece 208. The canister and cap pieces 208, 210 include angled end flanges 214, 216 that fit within a channel 218 of the v-band clamp 212. The channel 218 has a v-shaped transverse cross-sectional shape and extends circumferentially about the end flanges 214, 216 such that the flanges are mechanically joined together. The channel 218 is surrounded by a strap 219 that can be tightened about the flanged joint by a bolt arrangement 221 that draws the ends of the strap toward one another to constrict the strap diameter. When the diameter of the strap constricts, the channel 218 is drawn down against the angled surfaces of the flanges 214, 216. The outer radial flange 74 of the first end cover 40 of the exhaust filter 28 can be clamped between the flanges 214, 216 to assist in stabilizing the exhaust filter 28 within the outer housing 200. Additionally, a stabilizing member 220 can extend from the outer housing 200 and into the central open passage 55 of the inner liner 52 to stabilize the exhaust filter 28 at a position where the exhaust filter 28 is concentric with the outer housing 200. The stabilizing member 220 includes a first end 222 positioned within the passage 55 of the inner liner 52 and a second end 224 secured to a blind end 226 of the canister piece 208.

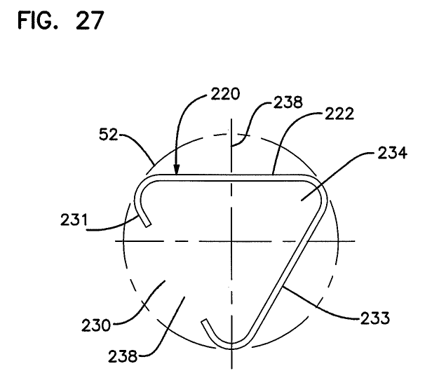

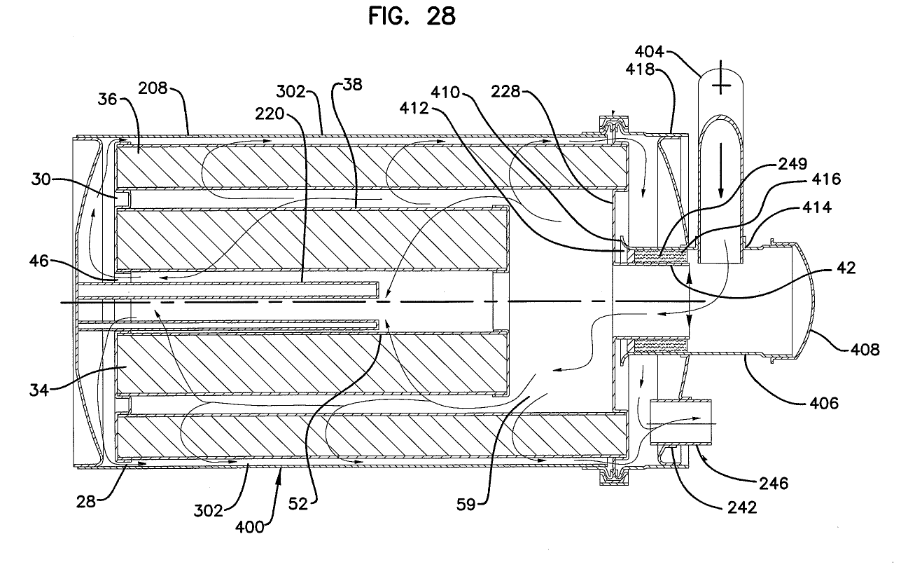

As shown at FIG. 27, the stabilizing member 220 has a generally triangular cross-sectional shape and is configured to be press-fit within the passage 55 of the inner liner 52. A gap 230 provided at one of the sides 231 of the stabilizing member 220 allows the other sides 232, 233 of the stabilizing member 220 to flex toward one another about point 234 during insertion of the stabilizing member 220 into the inner liner 52. Thus, the stabilizing member 220 is resiliently biased against the inner liner 52 of the exhaust filter 28 to assist in centering the stabilizing member 220 within the liner 52 as shown at FIG. 27. Open regions 238 are provided between the stabilizing member 220 and the inner liner 52 for allowing filtered exhaust to flow axially through the passage 55 without interference from the stabilizing member 220.

As indicated above, the inlet 202 and outlet 204 of the outer housing 200 can be provided at one end 206 of the housing 200. In one embodiment, the cap piece 210 of the outer housing 200 defines a first necked opening 240 at the inlet 202 and a second necked opening 242 at the outlet 204. An outlet pipe 246 is secured (e.g., welded) within the second necked opening 242. The first necked opening 240 is sized to slidably receive the inlet stub 42 of the exhaust filter 28.

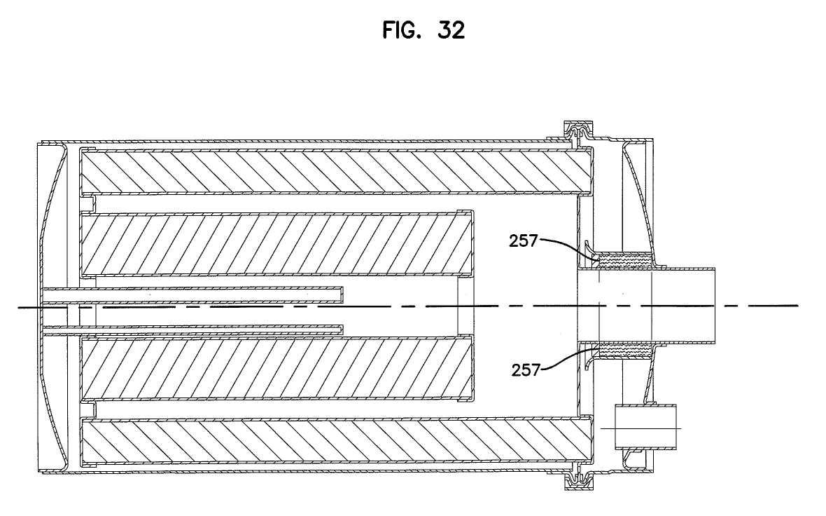

A sealing arrangement 248 is provided at the inlet 202 between the outer surface of the inlet stub 42 and the outer housing 200. The sealing arrangement 248 includes a gasket material 249 that is compressed between an outer surface of the inlet stub 42 and an inner surface of a gasket compression sleeve 250. The gasket material 249 is compressed in a radial orientation (see orientation R) relative to a central axis of the inlet stub 42. The gasket material 249 can include a material such as fiberglass or silicon that is layered (e.g., stacked or wrapped) around the outer diameter of the inlet stub 42. The gasket compression sleeve 250 surrounds and is generally concentric with the inlet stub 42. The gasket compression sleeve 250 includes a first end 252 that is secured (e.g., welded) to an inner surface of the cap piece 210, and a second end 254 that is spaced from the inner surface of the cap piece 210. The second end 254 has a tapered inner diameter 255 that is transitioned to increase in size as the gasket compression sleeve 250 extends away from the cap piece 210. In this way, the transition provides a bell mouth at the second end 254. In an alternative embodiment, a flange 257 (see FIG. 32) can be welded about the exterior of the inlet stub 42 to prevent the gasket material 249 from axially sliding on the inlet stub 42 during insertion of the stub 42 into the gasket compression sleeve 250. The flange 257 can also function to axially compress the gasket material 249 within the gasket compression sleeve 250.

To assemble the exhaust filter 28 within the outer housing 200, the cap piece 210 is removed from the canister piece 208 and the first end 30 of the exhaust filter 28 is inserted through the open end 228 of the canister piece 208. As the exhaust filter 28 is inserted into the canister piece 208, the stabilizing member 220 fits within the inner liner 52 of the exhaust filter 28 to concentrically align the exhaust filter 28 within the canister piece 208. Insertion continues until the outer radial flange 74 of the exhaust filter 28 abuts against the flange 214 of the canister piece 208. In this position, the inlet stub 42 of the exhaust filter 28 projects outwardly through the open end 228 of the canister piece 208. The cap piece 210 of the outer housing 200 is then inserted over the open end 228 of the canister piece 208. During the cap piece insertion process, the inlet stub 42 enters the tapered inner diameter 255 of the gasket compression sleeve 250 and slides axially through the gasket compression sleeve 250 and the first necked opening 240 of the cap piece 210. As the inlet stub 42 slides through the gasket compression sleeve 250, the gasket material 249 is radially compressed to form a radial seal between the outer surface of the inlet stub 42 and the inner surface of the gasket compression sleeve 250. Insertion of the cap piece 210 continues until the outer flange 216 of the cap piece 210 abuts against the radial flange 74 of the exhaust filter. The v-band clamp 212 is then mounted over the flanges 214, 216 and tightened such that the flanges 214, 216 are compressed axially together within the v-shaped channel 218.

To remove the exhaust filter 28 from the outer housing, the v-band clamp 212 is removed and the cap piece 210 is pulled axially from the canister piece 208 to expose the open end 228 of the canister piece 208. Thereafter, the exhaust filter 28 can be pulled axially from the canister piece 208.

When used within an exhaust system, the outer housing 200 containing the exhaust filter 28 is placed in fluid connection with the exhaust of a diesel engine by inserting an exhaust pipe 300 from the engine into the interior of the inlet stub 42. The exhaust pipe 300 can be secured to the inlet stub 42 with a clamp such as a stepped clamp or a seal clamp. A further pipe (e.g., a tail pipe) can be connected to the outlet pipe 246 of the outer housing 200. As so installed, exhaust enters the outer housing 200 and the exhaust filter 28 through the inlet stub 42. Thereafter, the exhaust flow moves through the open region 59 to the annular gap 38. From the annular gap 38, the exhaust flows radially outwardly through the outer cylindrical pleated filter media 36 and radially inwardly through the inner cylindrical pleated filter media 34. The exhaust flow passing through the outer cylindrical pleated filter media 36 travels to an annular clean exhaust passage 302 located between the outer housing and the exhaust filter 28. The exhaust flow traveling radially inwardly through the inner cylindrical pleated filter media 34 travels into the central passage 55 and then out the central outlet opening 46. The exhaust exiting the central outlet opening 46 is directed radially outwardly to the annular clean exhaust passage 302 where the exhaust gas filtered by the inner cylindrical pleated filter media 34 mixes with the exhaust gas filtered by the outer cylindrical pleated filter media 36. Thereafter, the filtered exhaust gas flows through the annular clean exhaust passage 302, through the openings 76 defined by the outer radial flange 74 of the exhaust filter 28, to the inlet/outlet end 206 of the outer housing 200. Thereafter, the clean exhaust exits the outer housing 200 through the outlet pipe 246. The gasket material 249 provided at the inlet stub 42 prevents the filtered exhaust from leaking to atmosphere through the first necked opening 240.

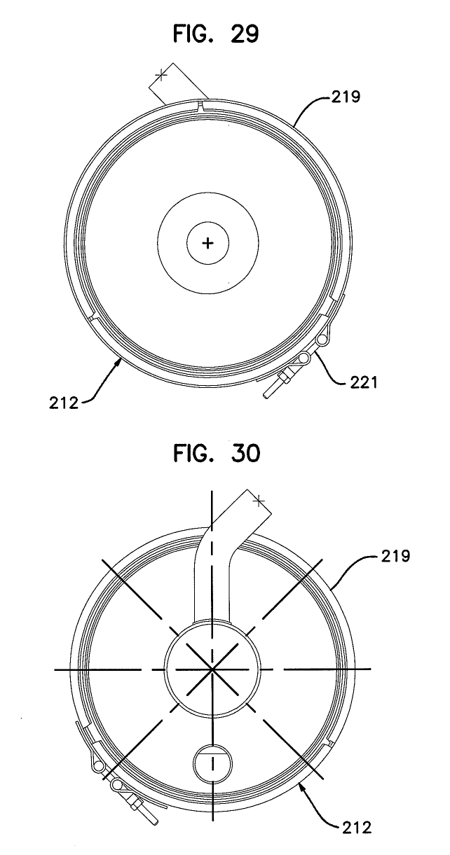

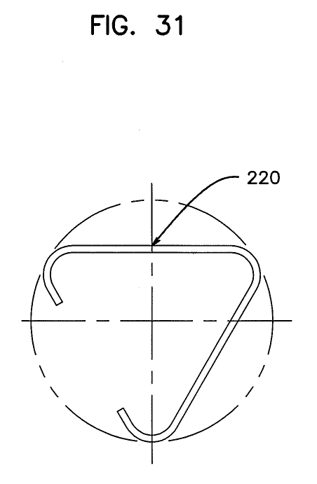

FIGS. 28-31 show an alternative outer housing 400 having features that are examples of inventive aspects in accordance with the principles of the present disclosure. The outer housing 400 has a similar configuration as the outer housing 200, and like parts have been assigned the same reference numbers. The outer housing 400 has been modified to include a side inlet pipe 404. The outer housing 400 also includes an inlet canister 406 aligned along a central longitudinal axis of the outer housing 400. The inlet canister 406 includes a blind end 408 and an open end 410. The open end 410 has a transitioned inner diameter 412 that forms a bell mouth. The inlet canister 406 also includes a necked opening 414 in which the side inlet tube 404 is secured (e.g., welded). The inlet canister 406 is secured (e.g., welded) within a necked central opening 416 defined by a cap piece 418 of the outer housing 400. Outlet pipe 246 is secured within necked opening 242 of the cap piece 418.

To assemble the exhaust filter 28 within the outer housing 400, the cap piece 418 is removed from the canister piece 208 and the first end 30 of the exhaust filter 28 is inserted through the open end 228 of the canister piece 208. As the exhaust filter is inserted into the canister piece 208, the stabilizing member 220 fits within the inner liner 52 of the exhaust filter 28 to concentrically align the exhaust filter 28 within the canister piece 208. Insertion continues until the outer radial flange 74 of the exhaust filter 28 abuts against the flange 214 of the canister piece 208. In this position, the inlet stub 42 of the exhaust filter 28 projects outwardly through the open end 228 of the canister piece 208. The cap piece 418 of the outer housing 200 is then inserted over the open end 228 of the canister piece 208. During the cap piece insertion process, the inlet stub 42 enters the transitioned inner diameter 412 of the inlet canister 406 and slides axially into the inlet canister 406. As the inlet stub 42 slides into the inlet canister 406, the gasket material 249 is radially compressed to form a radial seal between the outer surface of the inlet stub 42 and the inner surface of the inlet canister 406. Insertion of the cap piece 418 continues until outer flange 216 of the cap piece 418 abuts against the radial flange 74 of the exhaust filter 28. The v-band clamp 212 is then mounted over the flanges 214, 216 and tightened such that the flanges 214, 216 are compressed axially together within the v-shaped channel 218.

To remove the exhaust filter 28 from the outer housing 400, the v-band clamp 212 is removed and the cap piece 418 is pulled axially from the canister piece 208 to expose the open end 228 of the canister piece 208. Thereafter, the exhaust filter 28 can be pulled axially from the canister piece 208.

When used within an exhaust system, the outer housing 400 containing the exhaust filter 28 is placed in fluid connection with the exhaust of a diesel engine by connecting an exhaust pipe 300 from the engine to the side inlet pipe 404 and connecting a further pipe (e.g., a tail pipe) to the outlet pipe 246. As so installed, exhaust enters the outer housing 400 through the side inlet pipe 404, travels through the inlet canister 406 and enters the exhaust filter 28 through the inlet stub 42. Thereafter, the exhaust flow moves through the open region 59 to the annular gap 38. From the annular gap 38, the exhaust flows radially outwardly through the outer cylindrical pleated filter media 36 and radially inwardly through the inner cylindrical pleated filter media 34. The exhaust flow passing through the outer cylindrical pleated filter media 36 travels to the annular clean exhaust passage 302 located between the outer housing 400 and the exhaust filter 28. The exhaust flow traveling radially inwardly through the inner cylindrical pleated filter media 34 travels into the central passage 55 and then out the central outlet opening 46. The exhaust exiting the central outlet opening 46 is directed radially outwardly to the annular clean exhaust passage 302 where the exhaust gas filtered by the inner cylindrical pleated filter media 34 mixes with the exhaust gas filtered by the outer cylindrical pleated filter media 36. Thereafter, the filtered exhaust gas flows through the annular clean exhaust passage 302, through the openings 76 defined by the outer radial flange 74 of the exhaust filter 28, and exits the outer housing 400 through the outlet pipe 246. The gasket material 249 at the inlet stub 42 prevents the filtered exhaust from mixing with the unfiltered exhaust flowing through the inlet canister 406.

The dual filter configuration disclosed herein is advantageous because it provides a large amount of filtration capacity in a relatively small amount of space thereby allowing the filter to be used for applications where only small amounts of space are usable. Additionally, while the exhaust filter described herein is shown and described in an exhaust system, it will be appreciated that filters in accordance with the principles of the present disclosure can be used in other air filtration applications as well.

What is claimed is:

1. An exhaust filter comprising:
an inner cylindrical pleated filter media;
an outer cylindrical pleated filter media positioned outside the inner cylindrical pleated filter media, the inner and outer cylindrical pleated filter media being separated by an annular gap;
the inner cylindrical pleated filter media having a shorter length than the outer cylindrical pleated filter media;
a first end cover in which first ends of the inner and outer cylindrical pleated filter media are secured;
a second end cover in which a second end of the outer cylindrical pleated filter media is secured;
an interior end cap in which a second end of the inner cylindrical pleated filter media is secured; and
an inlet stub secured to the second end cover.

2. The exhaust filter of claim 1, wherein the second end cover includes an outer circumferential flange that extends radially outwardly beyond an outer diameter defined by the outer cylindrical pleated filer media, the outer circumferential flange defining a plurality of openings.

3. The exhaust filter of claim 1, wherein the inner cylindrical pleated filter media has a pleat depth that is at least 20 percent larger than a pleat depth of the outer cylindrical pleated filter media.

4. The exhaust filter of claim 3, wherein inner and outer cylindrical pleated filter media have pleat spacings of no more than 2 pleats per inch at dirty sides of the inner and outer cylindrical pleated filter media.

5. The exhaust filter of claim 1, wherein the second end cap extends continuously from an outer diameter of the outer cylindrical filter media to the inlet stub.

6. The exhaust filter of claim 1, wherein the inner cylindrical pleated filter media is at least 10 percent shorter than the outer cylindrical pleated filter media.

7. The exhaust filter of claim 1, further comprising an outer liner surrounding the outer cylindrical pleated filter media and an inner liner positioned within the inner cylindrical pleated filter media.

8. The exhaust filter of claim 1, wherein the inner and outer cylindrical pleated filter media include glass or ceramic fibers.

9. An exhaust filtering arrangement comprising:
an outer housing including a first housing piece detachably connected to a second housing piece, the second housing piece including a gasket compression member;
an exhaust filter that mounts within the outer housing, the exhaust filter having an inlet stub surrounded by a gasket material, wherein when the exhaust filter is enclosed within the housing, the inlet stub fits within the gasket compression member causing the gasket material to be radially compressed.

10. The exhaust filtering arrangement of claim 9, wherein the first housing piece includes a canister for receiving the exhaust filter, wherein the second housing piece includes a cap for enclosing one end of the canister, the cap defining an inlet and an outlet, the gasket compression member being attached to the cap at a location in general alignment with the inlet.

11. The exhaust filtering arrangement of claim 10, wherein the gasket compression member has an inner diameter that enlarges as the gasket compression member extends away from the cap.

12. The exhaust filtering arrangement of claim 9, wherein the gasket compression member has a bell-mouth configuration.

13. The exhaust filtering arrangement of claim 9, wherein the gasket material includes a layer including fiberglass.

14. The exhaust filtering arrangement of claim 9, wherein the gasket material includes a layer including silicon.

15. The exhaust filtering arrangement, further comprising a stabilizing member that fits inside the exhaust filter to concentrically align the exhaust filter within the outer housing.

16. The exhaust filtering arrangement of claim 15, wherein the exhaust filter includes concentric inner and outer cylindrical pleated filter media, wherein a metal liner is positioned within the inner cylindrical pleated filter media, and wherein the stabilizing member fits within the metal liner.

17. The exhaust filtering arrangement of claim 16, wherein the stabilizing member has a generally triangular cross-section having first, second and third sides.

18. The exhaust filtering arrangement of claim 17, wherein the first side of the stabilizing member includes a gap for allowing the second and third sides to flex toward one another during insertion of the stabilizing member into the exhaust filter.

19. The exhaust filtering arrangement of claim 15, wherein the stabilizing member has a resilient construction and is press-fit within the exhaust filter.

20. An exhaust filtering arrangement comprising:
an outer housing including a canister and a cap, the canister including an open end and a closed end, the cap being configured to enclose the open end of the canister, the cap defining an inlet and an outlet, the outer housing also including a gasket compression sleeve secured to the cap adjacent the inlet;
an exhaust filter that fits within the outer housing, the exhaust filter including:
an inner cylindrical pleated filter media;
an outer cylindrical pleated filter media positioned outside the inner cylindrical pleated filter media, the inner and outer cylindrical pleated filter media being separated by an annular gap;
the inner cylindrical pleated filter media having a shorter length than the outer cylindrical pleated filter media;
a first end cover in which first ends of the inner and outer cylindrical pleated filter media are secured;
a second end cover in which a second end of the outer cylindrical pleated filter media is secured, the second end cover including an outer circumferential flange that extends radially outwardly beyond an outer diameter of the outer cylindrical pleated filter media, the circumferential flange defining a plurality of flow openings, the circumferential flange being clamped between the cap and the canister when the exhaust filter is mounted in the outer housing;
an interior end cap in which a second end of the inner cylindrical pleated filter media is secured; and
an inlet stub secured to the second end cover surrounded by a gasket material, wherein when the exhaust filter is enclosed within the housing, the inlet stub fits within the gasket compression sleeve causing the gasket material to be radially compressed;
a stabilizing member that fits inside the inner cylindrical pleated filter media for stabilizing the exhaust filter within the canister;
wherein dirty exhaust enters the outer housing through the inlet at the cap, wherein the dirty exhaust is filtered within the outer housing by the exhaust filter to provide clean air, and wherein the clean air flows through an annular gap between the outer cylindrical pleated filter media and the canister and through the flow openings of the circumferential flange to reach the outlet at the cap.
